(19) United States
(12) Patent Application Publication
(10) Pub. No.: US 2007/0257808 A1
(43) Pub. Date: Nov. 8, 2007

(54) Remote control for a multimedia player

(76) Inventor: Chung-Hung Lin, Syuejia Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/417,106

(22) Filed: May 4, 2006

(51) Int. Cl. H04H 7/00; G08C 19/00

(52) U.S. Cl. 340/825.69; 455/3.06

(57) ABSTRACT

A remote control includes a transmitting and receiving unit, and a remote control unit; the transmitting and receiving unit is connected to a portable multimedia player, and includes a control mechanism, and a wireless transmitting and receiving mechanism; the remote control unit includes a control mechanism, and a display; in use, data relating to the portable multimedia player are read with the control mechanism, transmitted with the wireless transmitting and receiving mechanism of the transmitting and receiving unit, received with the wireless transmitting and receiving mechanism of the remote control unit, and shown on the display, which data include information relating to operation and the multimedia contents stored in the portable multimedia player; thus, the user is allowed to control the multimedia player with the remote control unit at a greater distance from the multimedia player, not having to look at the display of the multimedia player.

### BACKGROUND OF THE INVENTION

1. Field of the Invention

The present invention relates to a remote control for a portable multimedia player, more particularly one, which is equipped with a display for showing information relating to operation and the multimedia contents stored in the portable multimedia player, thus allowing the user to control the portable multimedia player with the remote control at a greater distance from the portable multimedia player.

2. Brief Description of the Prior Art

With progress of technology, a wide variety of multimedia equipments are developed for playing music, images, and sound, e.g. MP3 [MPEG-Movie Picture Experts Group-1 Layer3] players, MP4 [MPEG-4; Movie Picture Experts Group-4] players, CD [Compact Disk] players, VCD [Video Compact Disk] players, and DVD [Digital Versatile/Video Disk] players. Even cellular phones are provided with multimedia functions to play music, drawings, pictures, and images for providing more convenience.

The electronics industry is dedicated to making the various multimedia players with larger storage capacity and more compact. Consequently, portable multimedia players [PMP] are getting common. And, various multimedia accessories are made available for multimedia players to be used more conveniently, e.g. holding members with speakers, earphones, and remote controls.

Currently remote controls for multimedia players have buttons, but they aren't equipped with displays for showing information relating to operation and the multimedia contents of the multimedia players. Because common multimedia players have relatively small displays, which are used to show information relating to operation and the multimedia contents of the multimedia players, the users won't be able to see the information on the displays clearly if they are a long distance (more than one to two meters) apart from the multimedia players. In other words, the users still have to be relatively near to the multimedia players in using the remote controls otherwise the remote controls can't be operated conveniently. Consequently, the remote controls aren't convenient to use.

### SUMMARY OF THE INVENTION

It is a main object of the invention to provide an improvement on a remote control for a multimedia player to overcome the above problems. The remote control of the present invention includes a transmitting and receiving unit, and a remote control unit. The transmitting and receiving unit is connected to a portable multimedia player, and includes a control mechanism, and a wireless transmitting and receiving mechanism. The remote control unit includes a control mechanism, a wireless transmitting and receiving mechanism, and a display. In use, data relating to the portable multimedia player are read with the control mechanism, transmitted with the wireless transmitting and receiving mechanism of the transmitting and receiving unit, received with the wireless transmitting and receiving mechanism of the remote control unit, sent to the control mechanism of the remote control unit, and shown on the display for the user to see clearly, which data include information relating to operation and the multimedia contents stored in the portable multimedia player. Owing to the display of the remote control unit, the user is allowed to control the portable multimedia player at a great distance from the portable multimedia player, not having to look at the display of the multimedia player.

### BRIEF DESCRIPTION OF THE DRAWINGS

The present invention will be better understood by referring to the accompanying drawings, wherein:

FIG. 1 is a perspective view of the present invention,

FIG. 2 is a circuit block diagram of the transmitting and receiving unit,

FIG. 3 is a perspective view of the transmitting and receiving unit,

FIG. 4 is another perspective view of the transmitting and receiving unit,

FIG. 5 is a circuit block diagram of the remote control unit,

FIG. 6 is a perspective view of the remote control unit,

FIG. 7 a view of the remote control being used to control the multimedia player,

FIG. 8 is a view of the second preferred embodiment of the transmitting and receiving unit, and

FIG. 9 is a view showing the use of the second preferred embodiment of the transmitting and receiving unit.

### DETAILED DESCRIPTION OF THE PREFERRED EMBODIMENTS

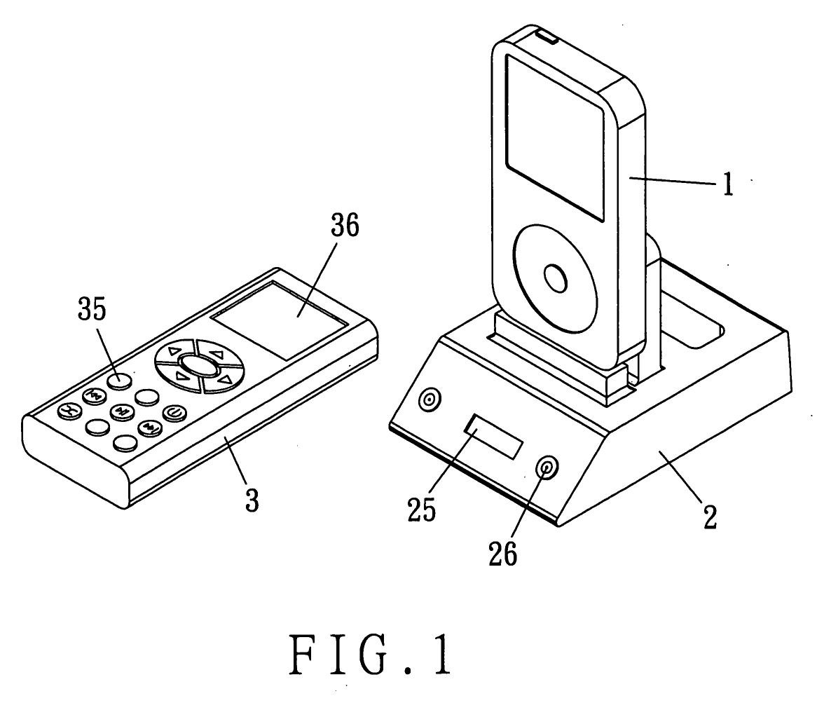

Referring to FIG. 1, a remote control is provided for use with a portable multimedia player 1. The remote control includes a remote control unit 3, and a transmitting and receiving unit 2.

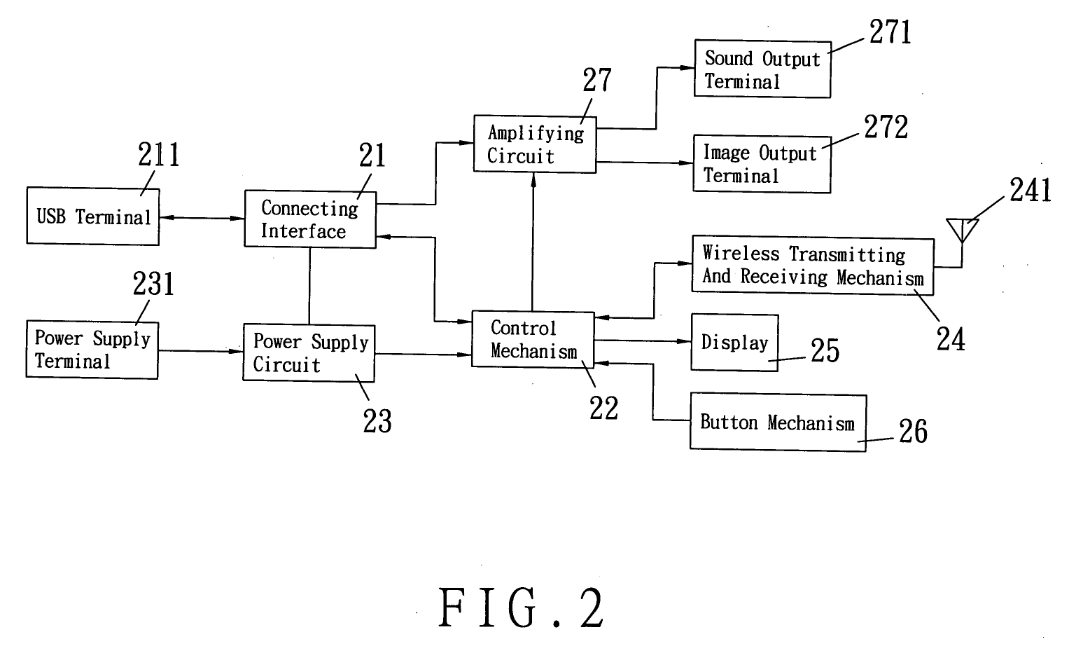

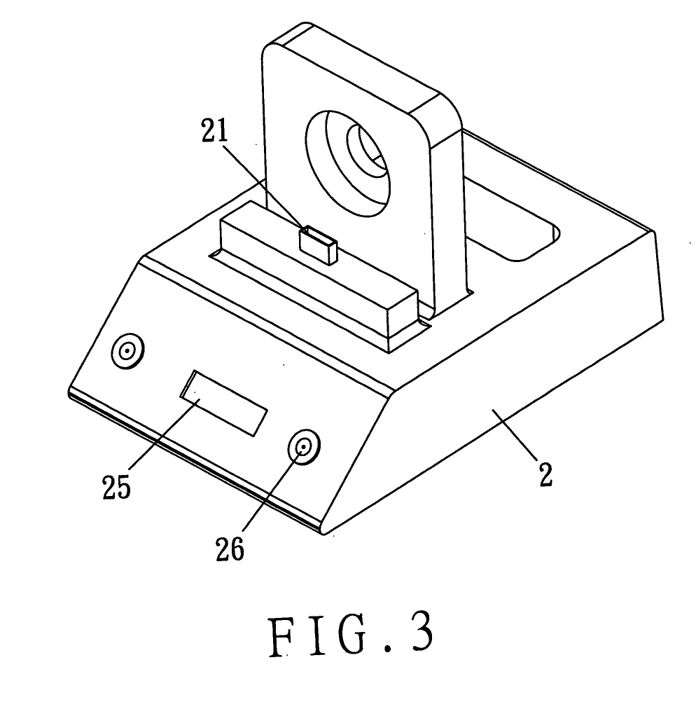

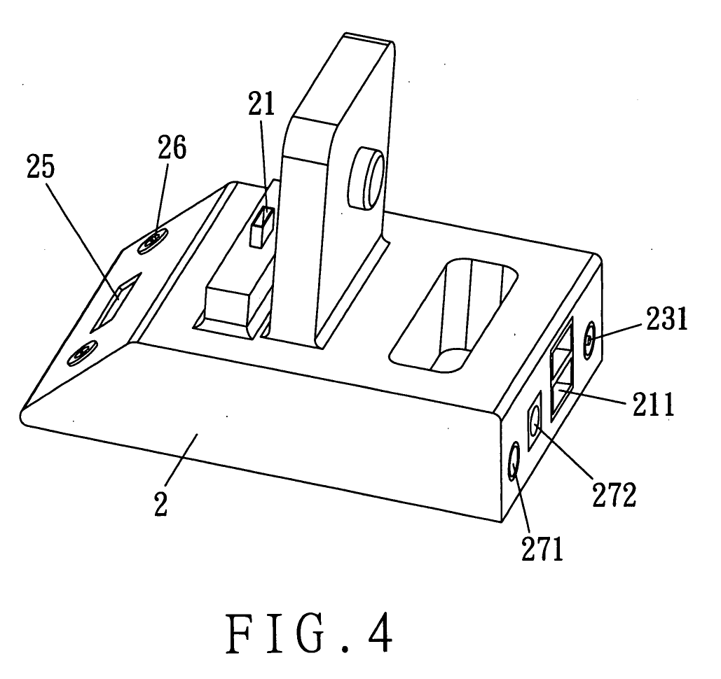

Referring to FIGS. 2 to 4, the transmitting and receiving unit 2 includes a connecting interface 21, a control mechanism 22, a power supply circuit 23, a wireless transmitting and receiving mechanism 24, a display 25, a button mechanism 26, and a magnifying circuit 27. The connecting interface 21 is provided for connection with the portable multimedia player 1, and an USB terminal 211 is connected to the connecting interface 21 for images, and video and audio data to be uploaded and downloaded through. The control mechanism 22 is electrically connected to the power supply circuit 23. The power supply circuit 23 has a power supply terminal 231 for connection to an external power source. Furthermore, the power supply circuit 23 has charging function for charging the portable multimedia player 1. The control mechanism 2 is connected to the wireless transmitting and receiving mechanism 24, which can be an IR module or a RF module, and which is equipped with an antenna 241 for signals to be transmitted and received through. The display 25 and the button mechanism 26 are connected to the control mechanism 22. The magnifying circuit 27 is interposed between the connecting interface 21 and the control mechanism 22. And, a sound output terminal 271 and an image output terminal 272 are connected to the magnifying circuit 27, which allow external devices such as speakers and TV to be connected thereto to produce better audio and video output.

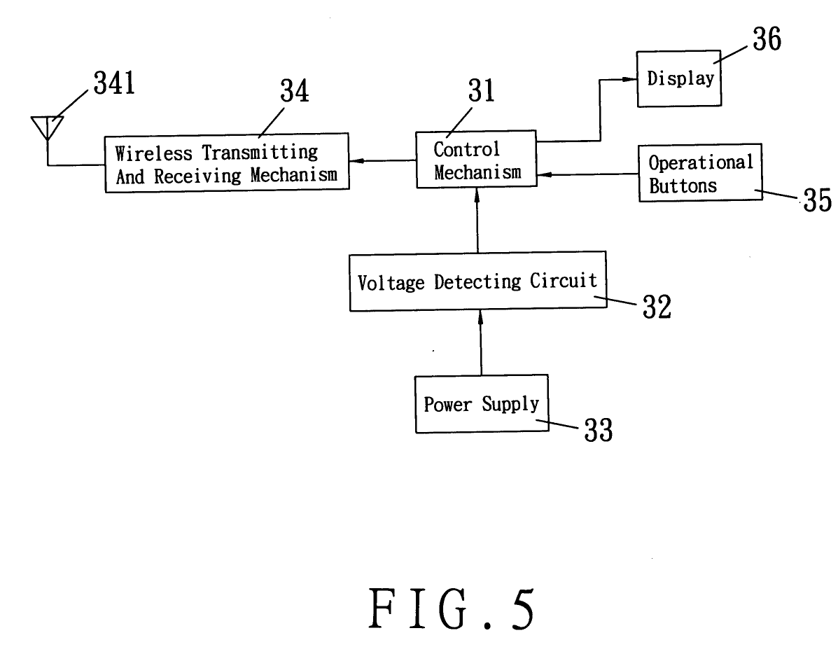

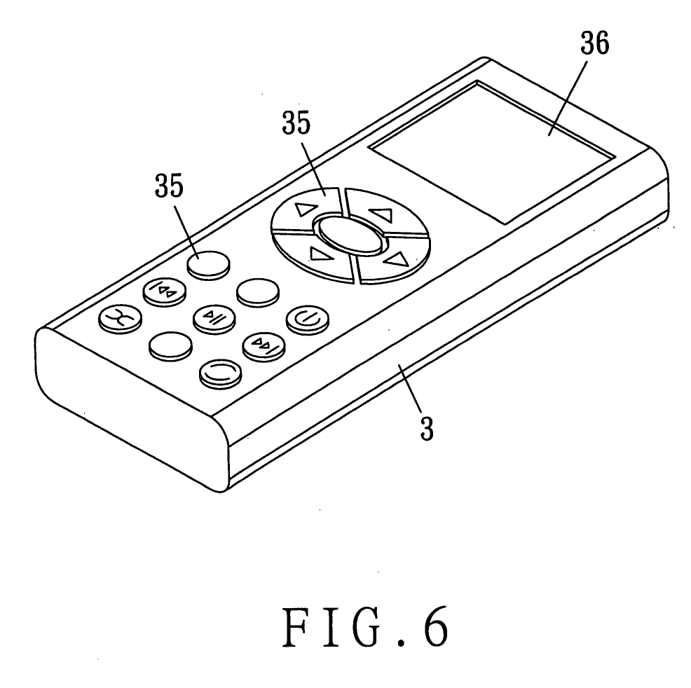

Referring to FIGS. 5 and 6, the remote control unit 3 includes a control mechanism 31, a voltage detecting circuit 32, a power supply 33, a wireless transmitting and receiving mechanism 34, several operational buttons 35, and a display 36. The voltage detecting circuit 32 is interposed between the control mechanism 31 and the power supply 33 for detecting the amount of electricity stored in the power supply 33, and it will indicate when the remote control unit 3 is running out of electricity. The wireless transmitting and receiving mechanism 34 is connected to the control mechanism 31, and equipped with an antenna 341 for signals to be transmitted and received through, and it can be an IR module or a RF module for use together with the wireless transmitting and receiving mechanism 24 of the transmitting and receiving unit 2. The display 36 and the operational buttons 35 are connected to the control mechanism 31.

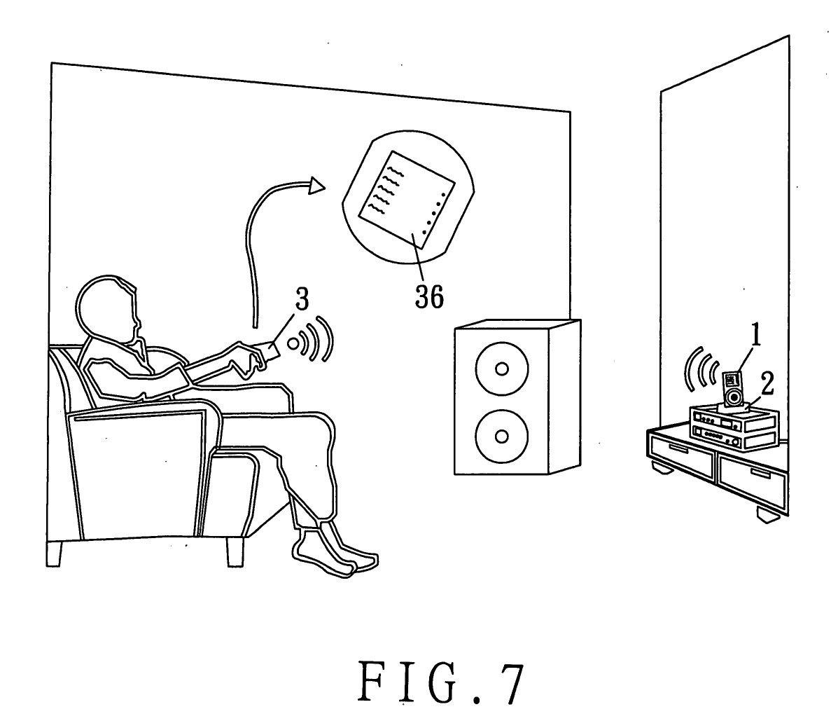

Referring to FIG. 7, to use the portable multimedia player 1 with the remote control, first the portable multimedia player 1 is connected to the connecting interface 21 of the transmitting and receiving unit 2. Thus, data relating to the portable multimedia player 1 are read by means of the control mechanism 22, transmitted through the antenna 241 by means of the wireless transmitting and receiving mechanism 24, received through the antenna 341 by means of the wireless transmitting and receiving mechanism 34 of the remote control unit 3, sent to the control mechanism 31, and shown on the display 36 of the remote control unit 3 for the user to see clearly, which data include information relating to operation and the multimedia contents stored in the portable multimedia player 1. Next, the user operates the operational buttons 35 to choose one among various lists of the multimedia contents, which chosen list will be shown on the display 36 synchronously, and he/she operates the operational buttons 35 to choose an item such as music, drawing, picture, and image from the current list. Consequently, signals are transmitted to the wireless transmitting and receiving mechanism 24 of the transmitting and receiving unit 2 through the antenna 341 of the wireless transmitting and receiving mechanism 34, and the control mechanism 22 controls and sets the portable multimedia player 1 accordingly, and the item chosen from the contents of the portable multimedia player 1 is played through external playing devices, which are connected to the sound output terminal 271, and the image output terminal 272 respectively; thus, better audio and video outputs are provided.

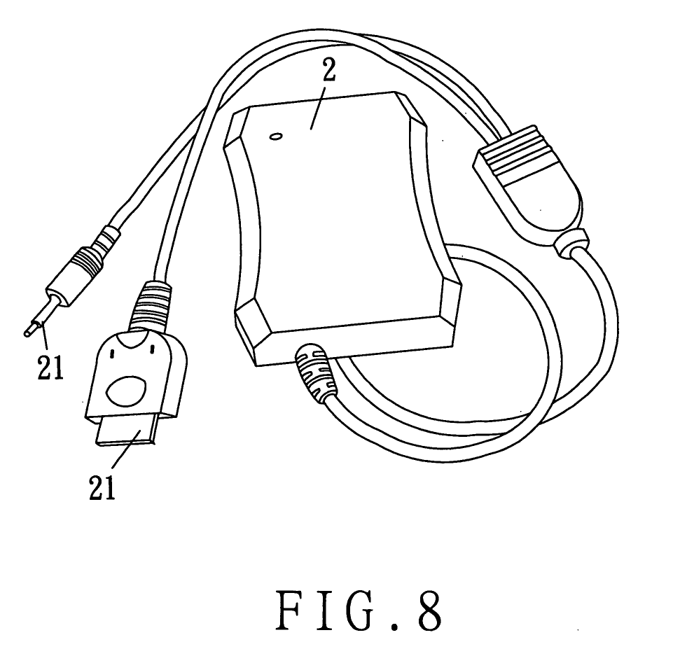

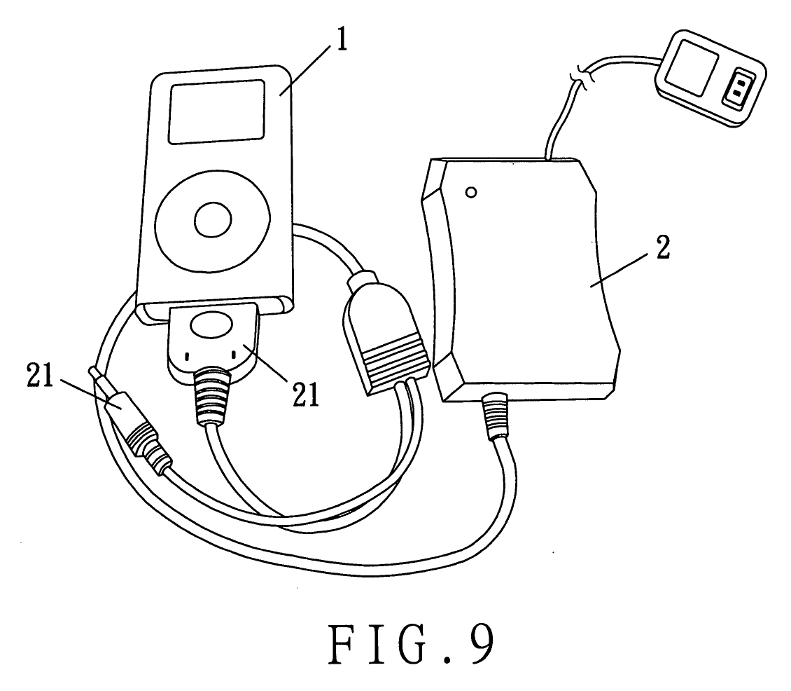

FIGS. 8 and 9 show a second preferred embodiment of a transmitting and receiving unit 2; the transmitting and receiving unit 2 is equipped with several different types of connecting interfaces 21 for allowing different types of portable multimedia players 1 to be connected thereto.

From the above description, it can be seen that the remote control of the present invention has an advantage over the prior art; after the portable multimedia player is connected to the transmitting and receiving unit of the remote control, information relating to operation and the multimedia contents in the portable multimedia player will be shown on the display of the remote control unit of the remote control therefore the user doesn't have be close to the portable multimedia player to see such information clearly when operating the remote control unit. In other words, the user is allowed to control the portable multimedia player with the remote control unit at a great distance from the portable multimedia player.

1. A remote control for a portable multimedia player, comprising:
(a) a transmitting and receiving unit connected to a portable multimedia player, the transmitting and receiving unit including:
a connecting interface for connection with a portable multimedia player;
a control mechanism;
a power supply circuit connected to the control mechanism, the power supply circuit being equipped with a power supply terminal for connection with an external power source;
a wireless transmitting and receiving mechanism connected to the control mechanism for transmitting and receiving signals, the wireless transmitting and receiving mechanism having an antenna;
a display connected to the control mechanism;
a button mechanism connected to the control mechanism;
an amplifying circuit interposed between the connecting interface and the control mechanism; and
a sound output terminal and an image output terminal connected to the amplifying circuit for allowing external playing devices to be connected thereto;
(b) a remote control unit, including:
a control mechanism having a power supply connected thereto;
a wireless transmitting and receiving mechanism connected to the control mechanism for transmitting and receiving signals, the wireless transmitting and receiving mechanism having an antenna;
a display connected to the control mechanism; and
a plurality of operational buttons connected to the control mechanism.

2. The remote control for a portable multimedia player as recited in claim 1, wherein an USB terminal is connected to the connecting interface for image, video and audio data to be uploaded and downloaded through.

3. The remote control for a portable multimedia player as recited in claim 1, wherein the remote control unit is equipped with a voltage detecting circuit for detecting amount of electricity stored in the power supply.

4. The remote control for a portable multimedia player as recited in claim 1, wherein the transmitting and receiving unit is equipped with a plurality of different types of connecting interfaces for allowing different types of portable multimedia players to be connected thereto.
